(19) United States
(12) Patent Application Publication
(10) Pub. No.: US 2009/0055221 A1
(43) Pub. Date: Feb. 26, 2009

(54) Health Profile Database Management System

(76) Inventors: Brian David Loftus, Bellaire, TX (US); Blakely Dean Long, Houston, TX (US); Alan Lawrence Pate, Houston, TX (US)

Correspondence Address: Robert F. Gilbert, 4219 Indian Sunrise Court, Houston, TX, 77059, US

(21) Appl. No.: 12/197,586

(22) Filed: Aug. 25, 2008

Related U.S. Application Data
(60) Provisional application No. 60/957,868, filed on Aug. 24, 2007.

(51) Int. Cl. G06Q 50/00

(52) U.S. Cl. 705/3

(57) ABSTRACT

Embodiments of the invention include a method of collecting and reporting quality of life data from a patient. A patient may participate in a collection of surveys during the course of disease treatment that are automatically tailored to the patient's disease state using multidimensional tools to generate quality of life metrics. Reports are generated from the aggregate data to aid in treatment of the patient by enhancing patient/healthcare provider communications, patient education and by giving the healthcare provider reports on quality of life metrics correlated to the prescribed treatments, comorbid diseases, disease specific and medication specific review of systems and patient compliance with the prescribed treatments. Further, data from multiple patients are aggregated for reports that can provide evaluations of the effect of prescribed treatments, reasons for patient non-compliance with prescribed treatments and the prevalence and effect of off-label use of medications.

### CROSS REFERENCE TO RELATED APPLICATION

This application claims the benefit of co-pending U.S. Provisional Patent Application Ser. No. 60,957,868 filed on Aug. 24, 2007, entitled “Health Profile Database Management System” which is incorporated herein by reference.

### BACKGROUND OF THE INVENTION

1. Field of the Invention

This application relates to a health profile database management system, and more particularly to using quality of life measures in patients suffering with chronic diseases to determine the effects of prescribed treatments.

2. Description of the Related Art

When prescribing treatments (i.e., medications, therapies and/or procedures) for patients with chronic non-progressive diseases, the physician's goal is to improve the patient's quality of life. Such diseases may include chronic pain, relapsing remitting multiple sclerosis, fibromyalgia, epilepsy, and the like. However, some prescribed treatments are directed towards symptoms, and do little to improve quality of life for the patient.

In order to assess the disease state, the patient may be asked a series of subjective questions by a healthcare provider (i.e., any one of a number of physicians, physician assistants, nurses, technicians, etc. that may be involved with the patient, the disease state or the treatment) during a short office visit. In particular, patients with chronic diseases may attempt to describe how they feel their medication is working and how their disease treatment plan is impacting their overall well-being. The physician may then review the patient's chart and adjust their treatment plan on the basis of the patient's subjective responses to the questions. However, such an interview-based approach is narrowly focused, and may thus not be useful in effectively managing the patient's overall quality of life. Further, such an approach is limited by time and cost constraints on the physician.

### SUMMARY OF THE INVENTION

One embodiment of the invention includes a computer-implemented method. The method may generally comprise the steps of: receiving a plurality of prescribed treatments for the patient, the prescribed treatments being prescribed at the same or different times; receiving, from the patient, a plurality of surveys responses, each survey response comprising (i) patient identification data, (ii) a disease state of the patient, and (iii) at least one quality of life metric measuring the patient's quality of life at a different point in time; aggregating the plurality of prescribed treatments and the plurality of survey responses in a database; and generating, based on the aggregated plurality of prescribed treatments and plurality of survey responses, a time-sequenced report that illustrates one or more effects of at least one prescribed treatment on the at least one quality of life metric.

Another embodiment of the invention includes a computer-implemented method. The method may generally comprise the steps of: receiving a plurality of prescribed treatments for the plurality of patients at a plurality of points in time; receiving, from each of the plurality of patients, a plurality of surveys responses, each survey response comprising at least one quality of life metric measuring a corresponding patient's quality of life at a different point in time; aggregating the plurality of prescribed treatments and the plurality of survey responses from each of the plurality of patients in a database; and determining, based on the aggregated plurality of prescribed treatments and plurality of survey responses from each of the plurality of patients, at least one measure of the effect of a prescribed treatment.

Yet another embodiment of the invention provides a computer-readable storage medium containing a program which, when executed, performs an operation. The operation may comprise the steps of: receiving a plurality of prescribed treatments for the patient, each prescribed treatment being prescribed at the same or different times; receiving, from the patient, a plurality of surveys responses, each survey response comprising (i) patient identification data, (ii) a disease state of the patient, and (iii) at least one quality of life metric measuring the patient's quality of life at a different point in time; aggregating the plurality of prescribed treatments and the plurality of survey responses in a database; and generating, based on the aggregated plurality of prescribed treatments and plurality of survey responses, a time-sequenced report that illustrates one or more effects of at least one prescribed treatment on the at least one quality of life metric.

Yet another embodiment of the invention provides a system, comprising: a processor; a database; and a memory containing a program configured to perform an operation. The operation may comprise the steps of: receiving a plurality of prescribed treatments for the patient, each prescribed treatment being prescribed at a different time; receiving, from the patient, a plurality of surveys responses, each survey response comprising (i) patient identification data, (ii) a disease state of the patient, and (iii) at least one quality of life metric measuring the patient's quality of life at a different point in time; aggregating the plurality of prescribed treatments and the plurality of survey responses in a database; and generating, based on the aggregated plurality of prescribed treatments and plurality of survey responses, a time-sequenced report that illustrates one or more effects of at least one prescribed treatment on the at least one quality of life metric.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a flow diagram illustrating a method for processing medical information describing a patient, according to one embodiment of the invention.

FIG. 2 illustrates an exemplary set of starting instructions for a patient, according to one embodiment of the invention.

FIG. 3 illustrates an exemplary baseline report for a patient, according to one embodiment of the invention.

FIG. 4 illustrates an exemplary follow-up report for a patient, according to one embodiment of the invention.

FIG. 5 illustrates an exemplary follow-up instruction sheet for a patient, according to one embodiment of the invention.

### DETAILED DESCRIPTION OF EMBODIMENTS

The meaning of the term “better quality of life” varies widely but to a person with chronic pain, relapsing remitting multiple sclerosis, fibromyalgia or epilepsy, the utmost importance is placed on acquiring and maintaining it. In research studies, physicians use various multidimensional, quality of life measurement scales. Such scales may be useful in identifying effective treatments. Correlating quality of life metrics over time can show the need for a change in the patient's treatment plan and can enable physicians to determine the most successful treatment.

However, physicians in clinical practice cannot easily and cost-effectively implement quality of life scales in their routine practice for a variety of reasons. Different diseases require different scales and given that many physicians in clinical practice treat a variety of diseases, this would be very cumbersome for them to maintain. Some of the scales require significant time to score but insurance companies, Medicare and patients do not reimburse physicians for this time consuming task. Additionally, an individual score by itself is not particularly meaningful, but rather, comparing the results of a scale over time in order to detect trends in the patients quality of life is data that is much more significant. Furthermore, accumulating an individual's scores over time without also tracking the treatment changes that were made will not assist the physician and patient in choosing the most effective therapy. Physicians in clinical practice recognize the importance of their patients' quality of life; it is just not possible for them to measure it and have a decent quality of life themselves.

Over time modifications are made to medication doses, medications are changed, patients may forget how a medication once made them feel and they didn't really convey their experience to their physician, or maybe they have forgotten how much progress has really been made on a particular treatment therefore they just don't think it is worth the cost anymore. In the case of chronic diseases like those named above, a physician will typically check one patient measurement only and not examine how the treatment is effecting the patients overall quality of life. The net result; patients suffering from chronic, long-term and sometimes painful diseases do not have what is generally most important to them evaluated by their physician, their overall quality of life.

Physicians in clinical practice could administer multidimensional scales to their patients on paper and then score the results manually. However, a single score by itself is not very useful so he would need to correlate the change in the patient's score over time with treatment changes in order to determine the impact they are having on the patient's quality of life and which treatments are optimal. This would very time intensive if not completely prohibitive. If the physician treats multiple diseases (e.g. epilepsy, multiple sclerosis, and chronic pain) then he must maintain multiple tools. However, using pen and paper to thoroughly measure quality of life to the same extent as our process would be a very cumbersome, expensive and complex task. Other issues affecting healthcare providers are the need to remind patients of appointments, and the need to provide patients with educational materials on medications and diseases.

Medications are effective at treating diseases but many patients do not take them following the directions given by their healthcare provider. In order to judge how beneficial a treatment plan is for a patient, medication compliance is essential. Non-compliance lowers the effectiveness of most medications and may even cause harmful side effects. A patient's non-adherence to their medication regimen could be related to their fear of drug to drug interactions, unwanted side effects, a perceived lack of medication effectiveness, a misunderstanding about the need to take the medication, or financial issues.

In many situations, pharmaceutical companies only have access to a physician's prescribing habits. For example, a pharmaceutical company can purchase data to determine which physicians are writing prescriptions for its own and its competitors' medications, but they have no way of knowing for which disease it is being prescribed, or if it is used off-label. By using the physician's specialty they try to estimate the reason for its use, but this is quite inaccurate for most physicians. This inaccurate data leads to the misappropriation of sales resources.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Embodiments of the invention include a method of collecting and reporting quality of life data from a patient. A patient may participate in a collection of surveys during the course of disease treatment that are automatically tailored to the patient's disease state using multidimensional tools to generate quality of life metrics. Reports are generated from the aggregate data to aid in treatment of the patient by enhancing patient/healthcare provider communications, patient education and by giving the healthcare provider reports on quality of life metrics correlated to the prescribed treatments, comorbid diseases, review of systems and patient compliance with the prescribed treatments. Further, data from multiple patients may be aggregated for reports that may provide evaluations of the effect of prescribed treatments, reasons for patient non-compliance with prescribed treatments and the prevalence and effect of off-label use of medications.

In one embodiment of the invention, healthcare providers may be provided with data describing the effectiveness of various medications. There are many conditions which have no FDA approved treatments. Therefore, the drugs physicians commonly prescribe are outside the scope of the drug's approved label or indication. This is known as prescribing “off label”. Some medications that improve quality of life while also improving the patient's condition are more expensive than cheaper alternatives. Insurance companies commonly deny the use of more expensive off label medications, while promoting the use of cheaper off label medications that fail to improve quality of life. In one embodiment, an accurate reporting of the actual uses of medications is provided, including off-label uses. Pharmaceutical data can be aggregated by physician specialty and region. By analyzing disease specific quality of life data and medication use, pharmaceutical companies may be able to target potential areas for clinical trials where off-label use of their medication has shown improved quality of life outcomes. Publication of aggregate data of off-label use will help guide physicians to areas that medications can be effective and where they do not appear to be effective. This is particularly essential for good medical care in some areas of medicine such as the field of neuropathic pain since many of the less frequent causes of neuropathic pain are never formally studied.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; and (ii) writable storage media (e.g., floppy disks within a diskette drive, a hard-disk drive or random-access memory) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

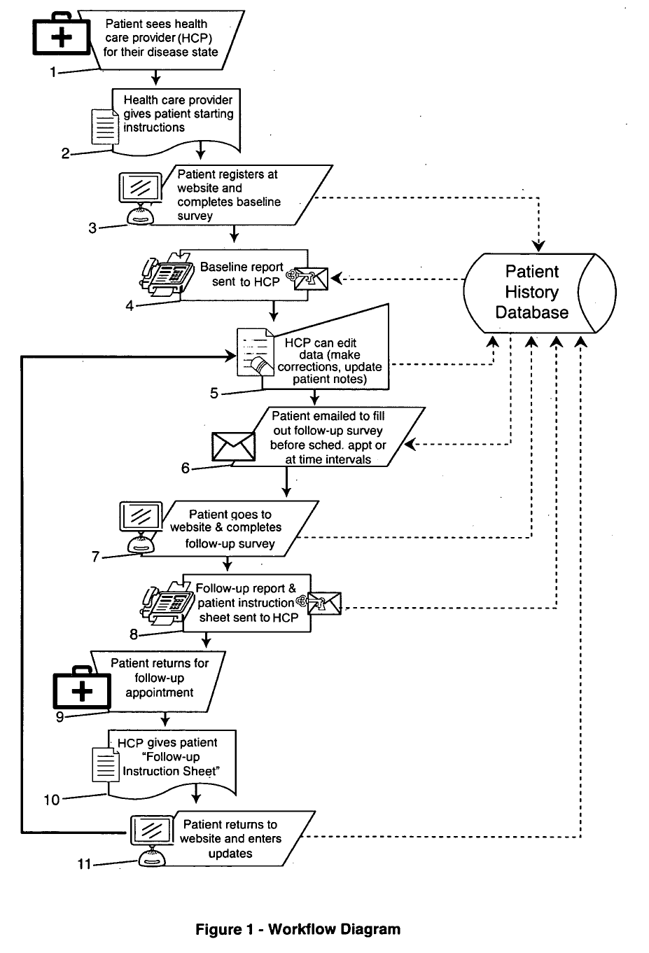

FIG. 1 is a flow diagram illustrating a method for processing medical information describing a patient, according to one embodiment of the invention. The flow diagram depicts a series of steps in a patient's interaction with a system configured for gathering quality of life data in a clinical practice. In one embodiment, the method illustrated in FIG. 1 may be performed using a network environment comprising a client-server configuration. Such a network environment may include one or more client computer systems, each including an interface that enables network communications with a server system, as well as other client computer systems in the network. The network may be a local area network where both a client system and a server system may reside in the same general location, or may be network connections between geographically distributed systems, including network connections over the Internet.

A client system may generally include a central processing unit (CPU) connected by a bus to memory and storage. Each client system is typically running an operating system configured to manage interaction between the computer hardware and the higher-level software applications running on the client system. The server system may include hardware components similar to those used by the client system (e.g., a CPU, a memory, and a storage device, coupled by a bus). However, such a network environment is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, embodiments of the invention may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

In one embodiment, users interact with the server system using a graphical user interface (GUI) provided by a user interface. In a particular embodiment, GUI content may comprise HTML documents (i.e., web-pages) rendered on a client computer system using a web-browser. In such an embodiment, the server system may include a Hypertext Transfer Protocol (HTTP) server (i.e., a web server) configured to respond to HTTP requests from the client system and to transmit HTML documents to client system. The web-pages themselves may be static documents stored on the server system or generated dynamically using an application server interacting with HTTP server to service HTTP requests.

Referring to FIG. 1, at step 1, a patient sees a healthcare provider (i.e., a physician) regarding their diagnosed disease (referred to herein as “disease state”). The physician examines the patient using traditional diagnostic means and identifies whether they have an appropriate disease state supported by our application.

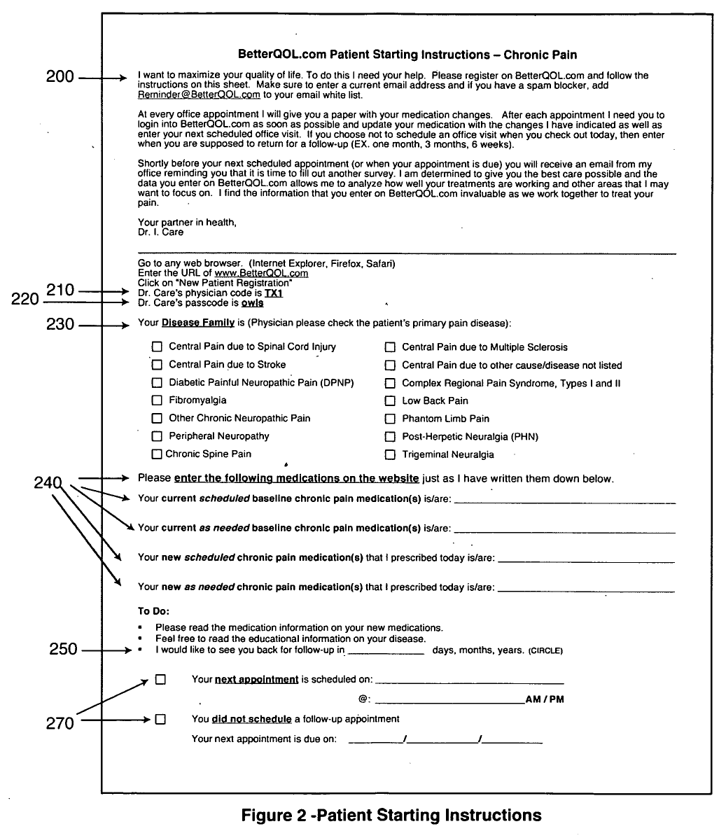

At step 2, the healthcare provider gives the patient starting instructions. For example, FIG. 2 illustrates an exemplary set of starting instructions, according to one embodiment of the invention. As shown, in FIG. 2, the healthcare provider may specify the patient's primary diagnosis (230) and the patient's medication (240) in the form including the starting instructions. The provider will also specify the timeframe for the patient to return for a follow up appointment (250). The healthcare provider support staff can write in the scheduled appointment date and time upon checkout or write the date the patient should follow-up if an appointment is not scheduled. (270) Note that the starting instructions shown in FIG. 2 are for the chronic pain disease state. However, the same principles may also apply to other diseases.

Referring again to FIG. 1, at step 3, a patient registers at a website and completes a baseline survey. Patient registration gathers initial information for a new patient account. A patient must have their physician's ID number (see 210 in FIG. 2) and physician pass code (see 220 in FIG. 2) from the patient starting instructions in order to register. The disease state and physician are associated with the patient's account. Patient information gathered includes name, gender, birth date, email address, cell phone, fax, address, height and weight. In addition patients will be asked to voluntarily provide their race and ethnicity to in accordance with the NIH standards for maintaining, collecting, and presenting data on race and ethnicity for all grant applications.

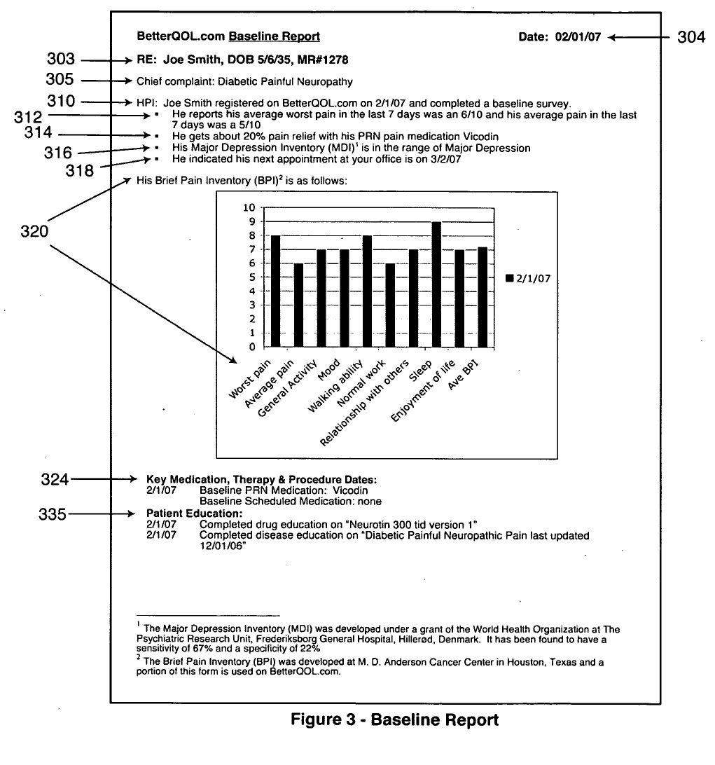

After completing registration, the user may be automatically logged in, and may be presented with the Baseline Patient Survey. Once the patient has finished the survey, the data is correlated into an easy to ready report. For example, FIG. 3 illustrates an exemplary baseline report according to one embodiment of the invention. The patient's name, date of birth and medical record number (303) are at the top of every page of the report. The date the patient completed the survey is also at the top of every page (304). The patient may complete the baseline survey soon after his appointment, as this represents a measure of his initial starting point on current intervention or without any intervention. For example, Table I (see below) illustrates information that may be included in the baseline patient survey.

TABLE I
INFORMATION IN EXEMPLARY BASELINE SURVEY

Chief Complaint (305)
History of Present Illness (HPI) - (310)

| | |
|---|---|
| 1. | Measure of Chief Complaint (312). |
| 2. | Effectiveness of “as needed medication” or “PRN |
| | medication” (314). |
| 3. | Comorbid Disease Screening (316). |
| 4. | Follow-up appointment plan- Patient enters their next scheduled |
| | appointment date and time so they receive a reminder to fill |
| | out the follow-up survey before their next appointment (318). |

Quality of Life Survey - The Multidimensional Tool(s) is administered and
correlated with medication changes (320).

| | |
|---|---|
| ii. | Comorbid Disease Metric - Additional multidimensional tool(s) |
| | selected based on primary disease state criteria. This is |
| | reported under the HPI (316). |

Key Medications, Therapy & Procedure Dates (324)

| iii. | Medications | |
|---|---|---|
| | 1. | New prescriptions and continued medications from the last |
| | | appointment. Includes both scheduled and PRN medication |
| | 2. | Medications the healthcare provider instructed the patient to |
| | | discontinue at the last appointment |
| | 3. | Medications tried in the past |
| iv. | Physical therapy and Complementary/Alternative Therapies | |
| | 1. | Newly prescribed and continued Physical therapy and |
| | | Complementary/Alternative Therapies at the last appointment |
| | 2. | Recent Physical therapy and Complementary/Alternative |
| | | Therapies from the past 30 days |
| | 3. | Physical therapy and Complementary/Alternative Therapies |
| | | tried in the past |

| | |
|---|---|
| v. | Past medical procedures |
| | Patient Education - When new medications or |
| | therapies are prescribed; |
| | patients are required to read education materials associated with |
| | medication/therapy and the disease state. The physician can |
| | customize the material or use the material provided. |
| | Documentation of education activities since the last |
| | visit is reported (335). |
| vi. | Patients may also read educational materials about their disease. |

Referring again to FIG. 1, at step 4, the physician may receive a baseline report (see FIG. 3). The baseline report is sent to the physician by fax and/or secure email. At step 5, the healthcare provider may edit the patient data. That is, the healthcare provider may make corrections to patient-entered data such as diagnosis and medication. The healthcare provider can enter any additional information regarding the patient's visit(s) into a free-form notes section.

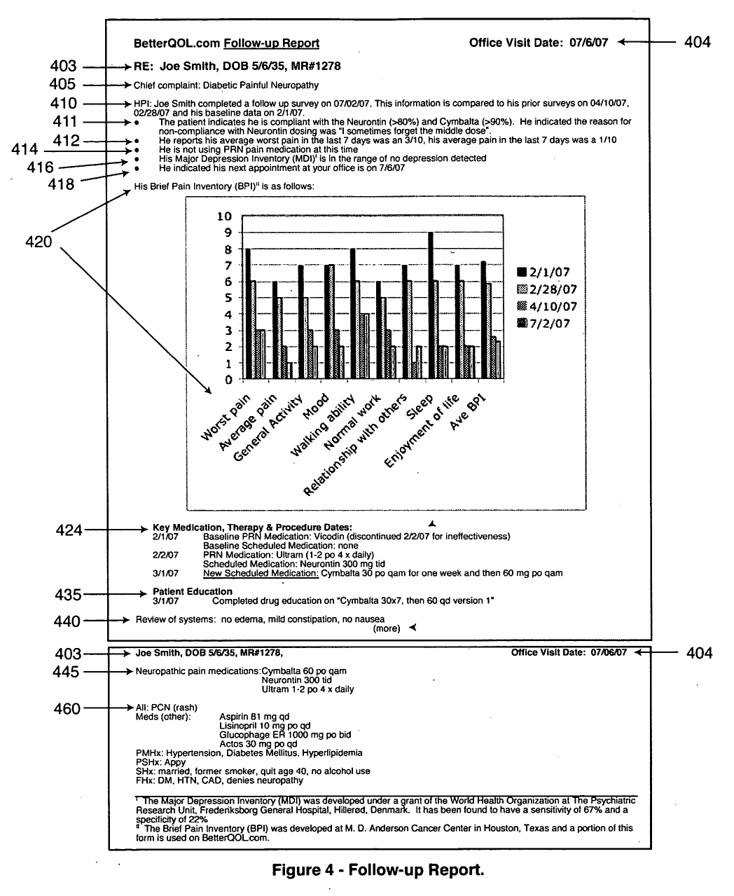

At step 6, the patient gets notification of next appointment and reminder to complete follow-up survey. At a specific amount of time before the patient's next visit, the patient receives an email with an appointment reminder and with instructions to complete the follow-up multidimensional survey on the website. At step 7, the patient may visit the website and complete the follow-up survey. Once the patient has finished the survey, the data may be correlated into an easy to ready report. For example, FIG. 4 illustrates an exemplary follow-up report, according to one embodiment of the invention. As shown, the patient's name, date of birth and medical record number (403) are at the top of every page of the report. The scheduled appointment follow-up date that the patient entered is also at the top of every page (404). For example, Table II (see below) illustrates information that may be included in the follow-up report.

TABLE II
INFORMATION IN EXEMPLARY FOLLOW-UP REPORT

Chief Complaint (405)
History of Present Illness (HPI) - (410)

| | |
|---|---|
| i. | Medication Compliance - Patient is asked questions in a non-threatening |
| | way about their medication compliance. If they are not compliant, they are |
| | asked why. (411) |
| ii. | Measure of Chief Complaint (412) |
| iii. | Effectiveness of “as needed medication” or “PRN medication” (414) |
| iv. | Comorbid Disease Screening (416) |
| v. | Follow-up appointment plan (418) |

Quality of Life Survey - The Multidimensional Tool(s) is administered and correlated
with medication changes. (420)

| | |
|---|---|
| vi. | Comorbid Disease Metric - Additional multidimensional tool(s) selected |
| | based on primary disease state criteria. This is reported under the HPI. |
| | (416) |

Key Medications, Therapy & Procedure Dates (424)

| vii. | Medications | |
|---|---|---|
| | 1. | New prescriptions and continued medications from the last |
| | | appointment. Includes both scheduled and PRN medication |
| | 2. | Medications the healthcare provider instructed the patient to |
| | | discontinue at the last appointment |
| | 3. | Medications tried in the past |
| viii. | Physical therapy and Complementary/Alternative Therapies | |
| | 1. | Newly prescribed and continued Physical therapy and |
| | | Complementary/Alternative Therapies at the last appointment |
| | 2. | Recent Physical therapy and Complementary/Alternative Therapies |
| | | from the past 30 days |
| | 3. | Physical therapy and Complementary/Alternative Therapies tried in |
| | | the past |

| | |
|---|---|
| ix. | Past medical procedures |

Patient Education - When new medications or therapies are prescribed; patients are
required to read education materials associated with medication/therapy and the disease
state. The healthcare provider can customize the material or use the material provided.
Documentation of education activities since the last visit is reported. (435)

| | |
|---|---|
| x. | Patients may also read educational materials about their disease. |

Review of Systems - The system asks review of systems questions specific to
medications, disease state, and/or custom specified by the healthcare provider. (440)
Current Medication(s) - medication(s) taken relating to the chief complaint are
reported (445)
Side effects of therapy - Patient can enter side effects of their medications in a free
form text area.
Issues to discuss at my next appointment - Patient can enter any questions or topics
they would like to discuss with the healthcare provider at the upcoming appointment.
This helps to ensure the topic is not overlooked.
Healthcare provider note area - The healthcare provider can copy static text that he
would like to store in the database to improve his documentation (460).

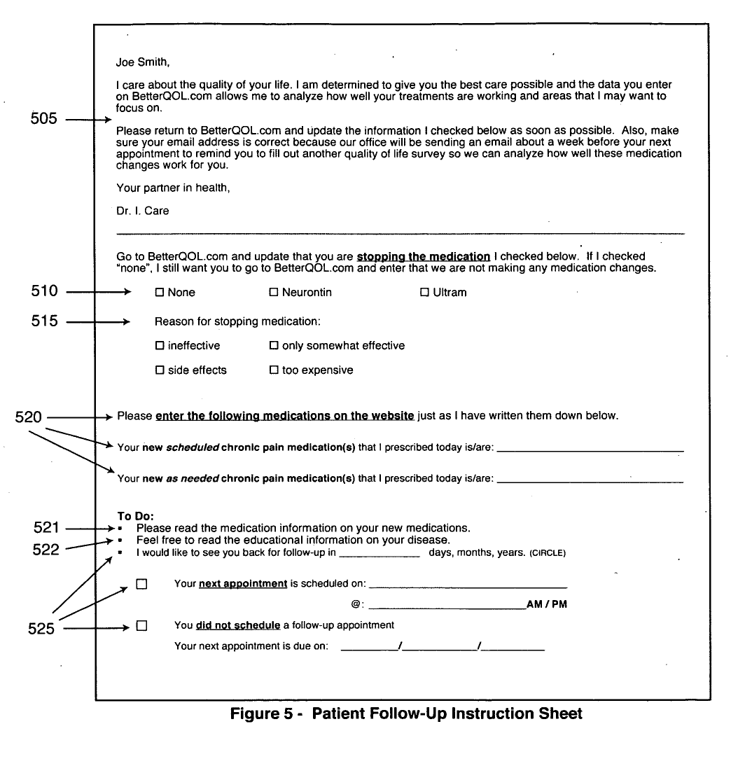

Referring again to FIG. 1, at step 8, the follow-up report and the patient instruction sheet (see FIG. 4 and FIG. 5, respectively) may be sent to the healthcare provider. The follow-up report may contain the patient survey history (baseline and follow-ups). The report can also include the results of data driven protocols that suggest modification of medications and therapies that have been demonstrated to improve patient outcomes while minimizing costs. At the same time the healthcare provider receives the follow-up report, a new “Follow-up Instruction Sheet” (FIG. 5) may be sent to the healthcare provider.

At step 9, the patient may visit the healthcare provider in a follow-up visit. The healthcare provider already has current medication summaries (424 & 445), review of systems (440), historical analysis & timelines (420) before the patient has even arrived at their appointment. The healthcare provider can use this cumulative data to determine what changes may need to be made in the treatment plan to maximize the patient's quality of life.

At step 10, the healthcare provider may give the patient the follow-up instruction sheet (FIG. 5). After the patient's follow-up visit, the healthcare provider fills in medication(s) being discontinued (510), reason for discontinuation (515); new scheduled and “PRN” medication (520) and their follow-up plan (525). At step 11, the patient returns to website and enters updates from the follow-up instruction sheet (FIG. 5). The top portion of the instruction sheet has a customizable letter from the healthcare provider (505).

In one embodiment, the post-follow-up patient survey may include a section for medication changes, in which the patient may enter medication changes from the Patient Follow-up instruction sheet (510, 515 & 520). Further, the post-follow-up patient survey may include a section for all new medications and therapies entered require the patient to read educational material associated with the medication/therapy and the disease state (521). Patients may also read educational materials about their disease (522). Furthermore, the post-follow-up patient survey may include a section for a next appointment date/time or follow-up time frame. This information may be required, as the site may contact the patient before their next appointment to take a follow-up survey, and to remind the patient of upcoming appointment. If patient has not scheduled an appointment then a follow-up time frame such a “two months” can be entered (525).

In one embodiment, the method shown in FIG. 1 may be repeated for multiple follow-up surveys. Thus, for each follow-up survey, the method shown in FIG. 1 may repeat at steps 5 to 11. The data gathered in multiple follow-up surveys (including patient identification data, a disease state of the patient, quality of life metrics measuring the patient's quality of life at the time of the survey, comorbid disease metrics, a measure of patient compliance with any prescribed treatments, and the like) may be aggregated in a patient history database. Further, data describing any prescribed treatments for the patient (e.g., prescribed medications, therapies and/or procedures) may also be aggregated in the patient history database. Such data describing any treatments may be received from the patient, may be provided by a healthcare provider, or may be obtained from another source (e.g., a network data source).

In one embodiment, the information aggregated in the patient history database may be used to generate a time-sequenced report. Such a report may be configured to illustrate any effects of prescribed treatments on the patient's quality of life metrics. Further, such a report may be provided to a healthcare provider upon request (e.g., a request entered in a web page). The information aggregated in the patient history database may be stored in anonymous form, meaning any data identifying specific patients may be removed from individual data records. Alternatively, the data may be stored in encrypted form, such that any identification data is only available to authorized users of the database.

In one embodiment, quality of life measures may be tracked over time, and may be correlated with treatment changes. Such techniques may be used to optimize patient care. In an embodiment, the system will administer a multidimensional tool appropriate for the patient's diagnosed disease state and then will correlate the patient's quality of life data with medication changes and other physician prescribed activities such as physical therapy, exercise regimens or lifestyle changes. Through the use of the system, healthcare providers and patients may be able to track how treatments effect the patient's overall quality of life. The data will show whether the medication/other activities have a positive, negative or neutral effect on the patient's quality of life.

The healthcare provider can use aggregated data of patient's quality of life and prescribed treatments to make further treatment decisions to reduce the burden of the patient's disease and improve their quality of life. Further, healthcare providers may be able to objectively measure how prescribed therapies are affecting patient's quality of life, in particular by tracking it over time. Furthermore, pharmaceutical companies may use aggregated data of patient's quality of life and prescribed treatments to determine if a given drug improves quality of life over time. Such use may include determining the effect of a prescribed medication for an off-label use.

In one embodiment, aggregated data of patient's quality of life and prescribed treatments may be used in automatically screening patients for comorbid diseases including depression, anxiety, and excessive daytime somnolence to name a few examples. Often, comorbid diseases accompany a primary disease. Because the focus is treating the primary disease, the secondary disease may go undiagnosed. For example, comorbid depression may afflict patients suffering from the chronic autoimmune disease Multiple Sclerosis (MS). Another example would be comorbid depression among patients suffering from chronic pain. Treating depression may improve quality of life faster than treating only the underlying pain disease. In one embodiment, the selection of the disease state is used to select the appropriate quality of life metric, as well as an appropriate comorbid disease metric (if applicable).

Of course, the described uses of the data gathered in the above-described method are merely illustrative, and are not intended to limit the invention. Other uses for such data are contemplated, and are thus considered to be within the scope of the invention. For example, such data may include research validated web based health disorder scales which may be used to measure and track over time patient quality of life. Such quality of life data may be used to quantify effects of medication intervention in order to rank their effectiveness, to determine why patients stop taking medications, and to determine how prescribing habits vary by physician specialty, region, and disease state. Further, such quality of life data may be used to provide accurate real world data for medication use in un-studied diseases, to identify comorbid diseases, to improve patient outcomes by using targeted therapies, to identify comorbid diseases, to determine the effect of physician prescribing habits in the presence versus absence of comorbid disease, and the like.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention.

It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A computer-implemented method of processing medical information describing a patient, comprising the steps of:
a) receiving a plurality of prescribed treatments for the patient, wherein each prescribed treatment being prescribed at a different time;
b) receiving, from the patient, a plurality of surveys responses, each survey response comprising (i) patient identification data, (ii) a disease state of the patient, and (iii) at least one quality of life metric;
c) aggregating the plurality of prescribed treatments and the plurality of survey responses in a database; and
d) generating, based on the aggregated plurality of prescribed treatments and plurality of survey responses, a time-sequenced report that illustrates one or more effects of at least one prescribed treatment on the at least one quality of life metric.

2. The computer-implemented method of claim 1, wherein each prescribed treatment comprises at least one of: (i) a medication, (ii) a therapy and (iii) a procedure.

3. The computer-implemented method of claim 1, wherein each survey response further comprises a measure of patient compliance with at least one prescribed treatment for the patient.

4. The computer-implemented method of claim 1, wherein each survey response further comprises a comorbid disease metric.

5. The computer-implemented method of claim 1, further comprising, in response to a query from a healthcare provider, providing the time-sequenced report.

6. The computer-implemented method of claim 1, wherein the plurality of prescribed treatments is received from the patient together with the plurality of surveys responses.

7. The computer-implemented method of claim 1, wherein the plurality of prescribed treatments is received from a healthcare provider.

8. The computer-implemented method of claim 1, further comprising, prior to receiving the plurality of surveys responses, providing a plurality of surveys to the patient, wherein each survey is correlated to the combination of the disease state and the prescribed treatment.

9. The computer-implemented method of claim 1, wherein each survey further comprises educational material related to the disease state and at least one of the plurality of prescribed treatments for the patient.

10. The computer-implemented method of claim 1, wherein each survey response further comprises a time and date for a next appointment of the patient with a healthcare provider.

11. The computer-implemented method of claim 1, wherein generating the time-sequenced report is also based on one or more notes provided by a healthcare provider.

12. The computer-implemented method of claim 1, wherein aggregating the plurality of prescribed treatments and the plurality of survey responses in the database comprises editing by a healthcare provider.

13. A computer-implemented method of processing medical information describing a plurality of patients, comprising the steps of:
a) receiving a plurality of prescribed treatments for the plurality of patients at a plurality of points in time;
b) receiving, from each of the plurality of patients, a plurality of surveys responses, each survey response comprising at least one quality of life metric measuring a corresponding patient's quality of life at a different point in time;
c) aggregating the plurality of prescribed treatments and the plurality of survey responses from each of the plurality of patients in a database; and
d) determining, based on the aggregated plurality of prescribed treatments and plurality of survey responses from each of the plurality of patients, at least one measure of effects of a prescribed treatment.

14. The computer-implemented method of claim 13, wherein each survey response further comprises a measure of patient compliance with at least one prescribed treatment for the patient.

15. The computer-implemented method of claim 13, wherein each survey response further comprises a comorbid disease metric.

16. The computer-implemented method of claim 13, wherein the plurality of prescribed treatments is received from the plurality of patients.

17. The computer-implemented method of claim 13, wherein the plurality of prescribed treatments is received from a healthcare provider.

18. The computer-implemented method of claim 13, wherein aggregating the plurality of prescribed treatments and the plurality of survey responses from each of the plurality of patients in the database comprises editing by a healthcare provider.

19. The computer-implemented method of claim 13, wherein aggregating the plurality of prescribed treatments and the plurality of survey responses from each of the plurality of patients in the database comprises removing any data that identifies any specific patient.

20. The computer-implemented method of claim 1, wherein aggregating the plurality of prescribed treatments and the plurality of survey responses from each of the plurality of patients in the database comprises encrypting any data that identifies any specific patient.

21. The computer-implemented method of claim 13, wherein at least one prescribed treatment is an off-label prescription, and wherein the at least one illustration of effects is for an off-label use of the prescribed treatment.

22. A computer readable storage medium containing a program for which, when executed by a processor, performs an operation, comprising the steps of:
a) receiving a plurality of prescribed treatments for a patient, each prescribed treatment being prescribed at a different time;
b) receiving, from the patient, a plurality of surveys responses, each survey response comprising (i) patient identification data, (ii) a disease state of the patient, and (iii) at least one quality of life metric;
c) aggregating the plurality of prescribed treatments and the plurality of survey responses in a database; and
d) generating, based on the aggregated plurality of prescribed treatments and plurality of survey responses, a time-sequenced report that illustrates one or more effects of at least one prescribed treatment on the at least one quality of life metric.

23. A system comprising:
a processor;
a database; and
a memory containing a program which, when executed by the processor, performs an operation, comprising the steps of:
a) receiving a plurality of prescribed treatments for a patient, each prescribed treatment being prescribed at a different time;
b) receiving, from the patient, a plurality of surveys responses, each survey response comprising at least one quality of life metric;
c) aggregating the plurality of prescribed treatments and the plurality of survey responses in the database; and
d) generating, based on the aggregated plurality of prescribed treatments and plurality of survey responses, a time-sequenced report that illustrates one or more effects of at least one prescribed treatment on the at least one quality of life metric.
